(19) United States
(12) Patent Application Publication
(10) Pub. No.: US 2012/0191352 A1
(43) Pub. Date: Jul. 26, 2012

(54) CDP Electromagnetic Marine Data Acquisition and Processing

(76) Inventors: Jostein Kåre Kjerstad, Stavanger (NO); Eduard B. Fainberg, Amersfoort (NL); Pavel Barsukov, Moscow (RU)

(21) Appl. No.: 13/384,550

(22) PCT Filed: Jul. 12, 2010
(86) PCT No.: PCT/NO2010/000281

§ 371 Date: Mar. 12, 2012

(30) Foreign Application Priority Data
Jul. 17, 2009 (NO) 20092699
Jun. 29, 2010 (NO) 20100945

(51) Int. Cl. G06F 19/00; G01V 3/12

(52) U.S. Cl. 702/6

(57) ABSTRACT

This application relates to a method and apparatus for the acquisition, processing and inversion of marine control source electro magnetic (CSEM) data. A system provides data acquisition and processing of the responses measured simultaneously by multiple receivers placed in a near zone and partly in the intermediate zone at different distances around the transmitter.

A method and an apparatus for the acquisition, processing and inversion of marine CSEM data are described. According to the invention, the system provides data acquisition and processing of the responses measured simultaneously by multiple receivers placed in the near zone and partly in the intermediate zone at different distances around the transmitter.

A common method of CSEM (Control Source Electro Magnetic) exploration is carried out by locating multiple electromagnetic n recorders along a straight line on the sea floor. A powerful electric current source (transmitter) is located on a vessel, and pushing current pulses into a cable embedded in sea water produces an electromagnetic field which induces an electromagnetic field in a subsea structure. The resulting electromagnetic field is recorded for later analysis. CSEM is described in, i.a., US 2003/0052685 A (Ellingsrud et al., 2003), U.S. Pat. No. 6,628,119 B1 (Eidesmo et al., 2003), WO 02/14906 A1 (Ellingsrud et al., 2002), WO 03/034096 A1 (Sinha et al., 2003), WO 03/048812 A1 (MacGregor et al., 2003) and WO 2007/053025 (Barsukov et al., 2007).

A known problem in CSEM exploration is that of distinguishing the desired electromagnetic signals, which are induced in the subsea structure, from electromagnetic signals originating from geomagnetic pulsations, tides, streams, wind and swell, and other internal signals produced by instrumentation (ADC (analog-digital converter), drift of electrodes etc.) and by moving of transmitter and receiver cables. All these signals are recorded and are commonly referred to as “noise”. A known technique for suppressing noise is commonly referred to as “stacking”.

Such stacking technique involves the use of long and repeated measurements that decrease the productivity of CSEM surveying. At the same time, this technique can minimize the noise only in the cases when the noise is a random function of time. Quite often, the noise originates from sources which do not depend on time, for example from local anomalies of the sea floor relief, the inclination of recording lines, streams, etc. In such cases, stacking in time is useless.

However, in such cases another way of suppressing noise can n be applied, namely stacking in the space domain. Such an approach, named common depth point (CDP) or, in some cases, common mid-point (CMP), is used widely in seismics. The basic idea of the CDP method is stacking (accumulation and averaging) of reflections of waves from common pieces of layers at different locations of sources and receivers. Besides, it is assumed that the boundaries of the layers are inclined slightly (less than ˜3 degrees). Such an approach was suggested for the processing of radar data by Shafers (US 4430643) in 1984. An example of successful application of CDP processing for high-frequency electromagnetic (EM) data by ground-penetration radar (GPR) was demonstrated by Belov et al.

However, there is a principle difference between seismics and high-frequency EM sounding on the one hand and CSEM sounding on the other. The radar works at a very high frequency range (from 10 MHz to 5 GHz), and the EM field corresponds to the same wave formulas as the seismic field. In this case, the CDP seismic technology can be used directly on EM data. But at such a high frequency range, the EM field attenuates very quickly in conductive sea water and in underlying structures and cannot be used for hydrocarbon prospecting.

Strack (US 0071709 A1, 2008) has suggested a method of accumulating EM data called “common mid-point” (CMP) with subsequent “normal moveout correction” as a seismic method. According to this method, all the EM measurements are recalculated into apparent resistivity and then averaged. For the calculation of apparent resistivity, late-time asymptotics and a long distance (offset) are used, in reality a direct-current regime by large offsets, and transients are not utilized. Such sounding thereby has a low spatial resolution as far as a hydrocarbon target is concerned.

Thomsen et al. (U.S. Pat. No. 7,502,690 B2, 2009) have proposed the processing of t-CSEM data (t-CSEM technology) mostly as seismic data. It is mentioned that, in principle, the EM field used in the t-CSEM technology is different from a seismic field, but is still suggested that remnants of EM fields (which do not exist in diffusion EM fields) be analysed, for data then to be stacked with some empirical weighting. With such limitations, the results received and their resolution cannot be checked.

The invention has for its object to remedy or reduce at least one of the drawbacks of the prior art.

The object is achieved through features which are specified in the description below and in the claims that follow.

It is an object of the present invention to provide new and improved method of CSEM data acquisition for obtaining a greater amount of high-quality data concerning a subsea hydrocarbon structure.

It is another object of the invention to provide a new and improved CSEM processing method to enable suppression of the noise caused by local geoelectric inhomogeneities of section, by instrumentation, stream etc.

It is a further object of the invention to provide a new and improved CSEM method which gives the possibility of controlling the process of data acquisition simultaneously with the processing of the data.

The invention relates to a new method and apparatus for electromagnetic (EM) data acquisition, processing and inversion, providing effective accumulation (stacking) of EM responses containing information on an underground structure (layers) and electrical properties (resistivity). Together with seismic, well logging and other geological and geophysical data, this information gives the possibility of determining whether there are/is hydrocarbons or water in the reservoir.

The invention provides a new method for electromagnetic data acquisition in CSEM surveying. This method, which is further named Control Source Electro Magnetic Common Depth Point (CSEM CDP), is based on an idea of joint stacking of the response electromagnetic signal in both the time domain and the space domain with the aim of minimizing any noise and maximizing the signal-to-noise ratio.

Preferably, two conditions are taken as the basis for CSEM CDP:

a) the applied method of sounding must work in time domain, and
b) the relief and other underlying layers change smoothly in the vicinity of the sounding area.

Preferably, the electromagnetic surveying is carried out in series of groups along profiles or within the area previously identified as potentially containing a subsea hydrocarbon reservoir. Each CDP group consists of multiple receivers installed and working on the sea floor in the near zone around the transmitter.

The transmitter impresses, on a cable embedded in sea water, the current pulses with sharp fronts, and the receivers measure the EM responses.

Preferably, all the receivers are located at different distances (offsets) from the transmitter; that is to say, far enough to avoid an influence of IP (induced polarization) effect and close enough to have a signal-to-noise ratio acceptable for measurements.

Preferably, all the raw electromagnetic data recorded by receivers during surveying are stored, and the apparatus performs processing and inversion of stored marine electromagnetic data essentially in real time in accordance with the commands of an operator.

Preferably, all the data measured at a distance r between the transmitter and the receivers located around it, satisfying the condition of a near zone—that is to say, large enough for sufficient attenuation of the IP effect and small enough to provide consistent registration of EM response—are inverted all together and the result of the inversion is concerned with the circle centre of the radius r, the centre of the circle being the CDP.

The process may be controlled continuously by measurements and accumulation of data and, if necessary, the operator installs additional receivers to provide acceptable quality of the result.

After receiving acceptable results in one common depth point (CDP), the transmitter and the plurality of receivers can be moved to the next point along the profile or area.

In a first aspect, the invention relates more specifically to a method for the acquisition, processing and inversion of marine electromagnetic data recorded by a system consisting of a plurality of synchronously working devices arranged to register an electromagnetic field and installed on or near a sea floor while an electromagnetic field is excited by pulses of to electric current pumped in sea water by a pulse generator installed on board a vessel, said marine electromagnetic data being common depth point (CDP) marine electromagnetic data, characterized by said CDP marine electromagnetic data being the data selected from a plurality of raw records of the is electromagnetic field measured in time domain at a distance (offset) between a transmitter and a receiver, the distance satisfying the following conditions:

a) CDP marine electromagnetic data consist of only the galvanic mode of the electromagnetic field; and
b) all the receivers are located at a distance (offset) satisfying the condition r₁<r<r₂, in which r₁ is the distance from the transmitter at which the effect of induced polarization is insignificant as compared with the measured response signal, whereas r₂ is the distance from the transmitter at which the measured response signal is still considerable as compared with the noise and, besides, the receiver is still inside the near zone of the electromagnetic field determined by the condition r≦\sqrt{10⁷ρt/2}.

Said processing may involve inversion of said CDP electromagnetic data with respect to the resistivity of layers existing within the earth, and the vertical extent of said layers.

Said common depth point (CDP) electromagnetic data may be acquired by carrying out marine electromagnetic surveying operations comprising the steps of:
installation of the transmitter emitting, in sea water, electric current pulses in the centre of a selected receiver polygon located within the area previously identified as potentially containing a subsea hydrocarbon reservoir, while multiple receivers registering electromagnetic field responses are installed around the transmitter at some distances which probably satisfy the conditions a) and b) above;
registration and processing of the electromagnetic field responses, displaying of the responses and evaluation of whether they satisfy the conditions a) and b) above; in the case of some or all data not satisfying these conditions, modification of the location of the recorders, and repetition of the measurements;
assignment of start parameters for the resistivity of said layers and the vertical extent of said layers, performance of joint inversion of all acquired data satisfying said conditions a) and b) above, and determination of the resistivity and vertical extent of the layers;
repetition of the inversion with different start models and evaluation of found layers' thicknesses and resistivity accuracy;
installation of additional receivers inside the selected receiver polygon where the above-mentioned conditions a) and b) determining the validity of common depth point (CDP) electromagnetic data are fulfilled, and recurrent acquisition of common depth point (CDP) electromagnetic data if the attained accuracy is not satisfactory;
shift of the transmitter and receivers along the assigned profile passing within the area previously identified as potentially containing a subsea hydrocarbon reservoir, from the current receiver polygon to the adjacent receiver polygon and repetition of all the steps described above;
repetition of all the operations described above over all the area previously identified as potentially containing a subsea hydrocarbon reservoir, stitching of all the sections consisting of the resistivity and vertical extent found for said layers, and 3D visualization of the constructed resistivity model.

In a second aspect, the invention relates more specifically to an apparatus for the acquisition, processing and inversion of marine electromagnetic data, characterized by the fact that said marine electromagnetic data may be common depth point (CDP) marine electromagnetic data selected from a plurality of electromagnetic field records measured in the time domain at a distance (offset) between a transmitter and a receiver satisfying the conditions

a) CDP marine electromagnetic data consist of only the galvanic mode of an electromagnetic field; and
b) the receivers are located at a distance (offset) satisfying the condition r₁<r<r₂, in which r₁ is the distance from the transmitter at which the effect of induced polarization is insignificant as compared with the measured response signal, whereas r₂ is the distance from the transmitter at which the measured response signal is still considerable as compared with the noise, and the receiver is still inside the near zone of the electromagnetic field which is being generated by the transmitter.

The apparatus may include:
means arranged to store raw electromagnetic data received from marine electromagnetic surveying operations;
a mainframe computer, comprising means arranged to accept operator commands and means arranged to receive data from said means for storing raw data and to transmit raw data together with said operator commands to an array processor unit; and
an array processor unit which is arranged to receive said commands and said raw data from said mainframe computer unit and process and invert said data in accordance with said operator commands and visualize the results essentially in real time;
whereas said operator commands relate to the selecting of data which satisfy the CDP conditions according to items a) and b) above, processing and inversion of the CDP data accumulated in time and space, 3D visualization of a constructed target model, decision-making regarding the approval of the constructed target model and the necessity of continuing the measurements or changing the positions of the transmitter and the receivers.

For a better understanding of the present invention, together with other and further objects and features thereof, advantages of the proposed method as well as disadvantages of existing methods applied for marine electromagnetic surveying of hydrocarbons, reference is made to the description of the invention that now follows, referring to the appended drawings.

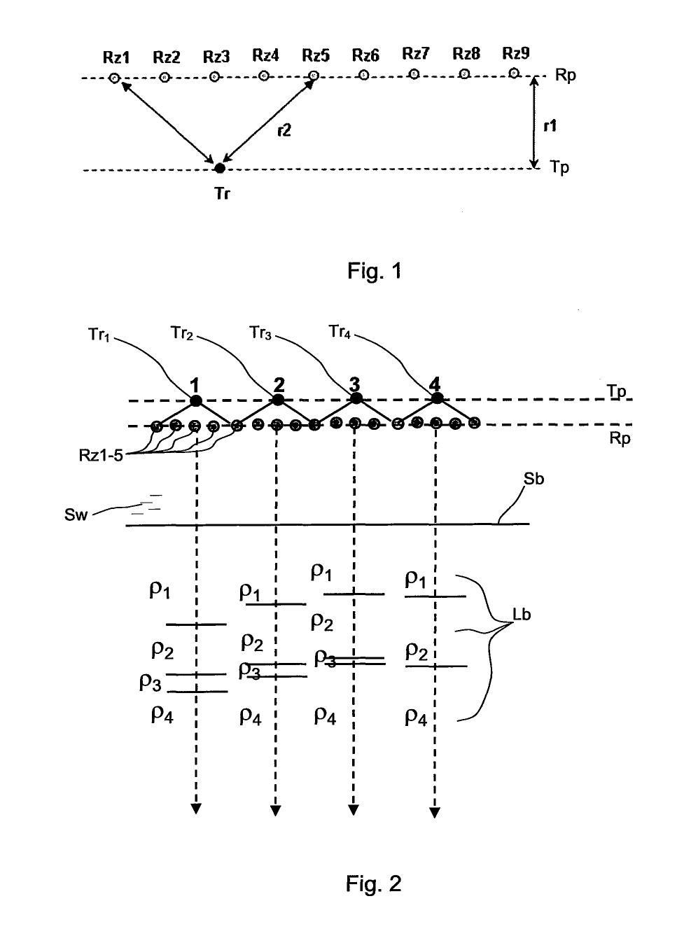

FIG. 1 depicts, in a ground plan, a scheme of usual CSEM profile surveying according the TEMP-VEL technology (Barsukov et al., 2007). The distance (offset) between the profiles Tp, Rp of the transmitter Tr and the receivers Rz1, Rz2, Rz3 etc. is r1, whereas r2 determines the area of the near and intermediate zones of the EM field;

FIG. 2 depicts, partially in a side view, partially in a plan view (the transmitter and receiver profiles Tp, Rp), a simple embodiment of a CSEM CDP array. The numbers 1, 2, 3, 4 show the locations of four common depth point areas. Each area includes a group consisting of a transmitter Tr located along the transmitter profile Tp and five receivers Rz located along the receiver profile Rp. Four schematic cross sections resulted from joint inversion of four data sets, the groups relating to four common depth points.

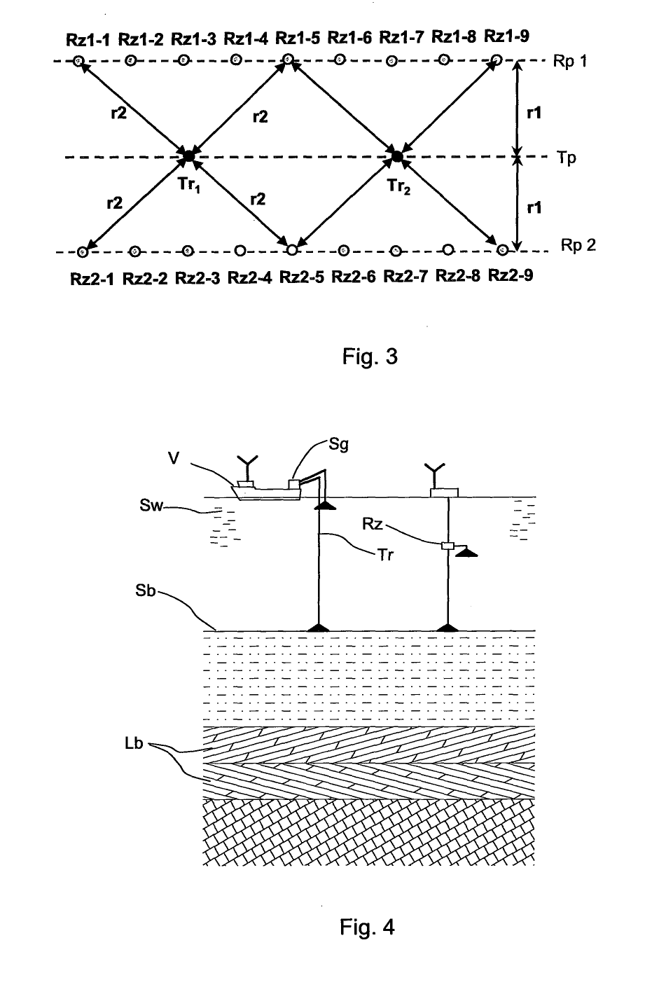

FIG. 3 depicts, in a ground plan, another example of a CSEM CDP embodiment. The efficiency of surveying is increased owing to the simultaneous measurements of response signals by receivers installed along two profiles Rp 1 and Rp 2.

FIG. 4 shows, in a side view, a general schematic apparatus array.

In the figures, Tr, Tr₁ . . . , Tr₄ indicate transmitters arranged to induce an electromagnetic field in sea water and an underlying structure including one or more layers Lb of different resistivities ρ₁, ρ₂, ρ₃, ρ₄. The transmitters Tr, Tr₁ . . . , Tr₄ are installed in sea water Sw above a sea floor Sb and are in signal communication with a signal generator Sg (see FIG. 4) which is arranged on a vessel V on a sea surface S. Tp indicates a transmitter profile.

A number of receivers Rz, Rz1, . . . , Rz9; Rz1-1, . . . , Rz1-9; Rz2-1, . . . , Rz2-9 are arranged to record the field strength and communicate the signal values to data storage means (not shown). Rp, Rp 1, Rp 2 indicate receiver profiles.

A mainframe computer (not shown) includes means arranged to accept operator commands and means arranged to receive data from said data storage means.

An array processor unit (not shown) is arranged to receive said commands and said data from said mainframe computer unit and process and invert said data in accordance with said operator commands and visualize the results essentially in real time.

In FIG. 1, which shows a ground plan of a transmitter/receiver scheme in a common CSEM profile survey, r1 indicates the distance (offset) between the profiles Tp, Rp for the transmitter Tr and the receivers Rz1, Rz2, Rz3 etc., whereas r2 defines the distance (offset) which satisfies the conditions for the near and intermediate zones of an EM field.

In FIG. 3, which shows a ground plan of a transmitter/receiver scheme for CSEM CDP profile surveying, Rz1-1, Rz1-5, Rz2-1, Rz2-5 indicate an example of a so-called receiver polygon around the transmitter Tr1. The receivers comprised by a receiver polygon exhibit a distance r2 satisfying the near zone conditions.

It is well known that for increasing a signal-to-noise ratio, two ways of accumulating signals from measurements of an electric field result, namely accumulation in time and accumulation in space. Accumulation in time is convenient for all existing CSEM methods.

However, not all existing CSEM methods used for hydrocarbon marine electromagnetic exploration can be improved by a spatial accumulation. This is explained by low spatial resolution of the methods working in the frequency domain, and is based on the principle of geometric sounding, for example, the SBL method (Ellingsrud et al., 2003; Eidesmo et al., 2002, 2003; Greer et al., 2004; MacGregor at al., 2000, 2003, 2004; Tompkins et al., 2004; Wicklund et al., 2004; Sinha et al., 2003 etc.), which is a marine modification of a wellknown direct-current sounding method proposed by C. Schlumberger in the 1920s.

Accumulation in space is possible only when applied to transient electromagnetic methods operating with the galvanic mode of the EM field in the near zone; for example, the TEMP-VEL and TEMP-OEL methods used only the vertical component of the electric field.

Simultaneous measurements and averaging of the vertical component of the electric field in N receivers Rz1, . . . , RzN located within a small territory around a source (transmitter) Tr₁, . . . , Tr₄ gives the possibility of increasing a signal-to-noise ratio proportional to factor \sqrt{N}, because the noise in these receivers Rz1, . . . , RzN is uncorrelated since the vertical component of the electric field from the noise is caused mainly by local inhomogeneities and cannot be the same for all receivers located in different places.

However, there are two limitations which give no possibility of using direct averaging of the signal.

First, the induced signal containing useful information about the cross section depends on distance between the transmitter and the receiver and, therefore, has different amplitudes at different distances.

Second, the useful signal is complicated by the effect of induced polarization (IP) which masks the signal and makes the inversion and interpretation of the acquired data hard.

The problem of these limitations can be solved by an appropriate choice of distance (offset). The optimal CDP area (circular ring) must satisfy the condition r₁<r<r₂, in which r₁ is the internal radius (offset) of the ring and r₂ is the external one. Both radii can be found from the next consideration.

The maximal distance (r₂ boundary) is determined by the end of the far zone of the EM field. In the time domain, the boundary of the far zone takes place at a time t at which the EM signal changes its sign. The time t depends mainly on the resistivity ρ of sedimentary rocks (till ˜500) and on the distance (offset): r˜\sqrt{10⁷ρt/2}. The maximal distance r₂ is Selected to be such that it is possible to provide the effective inversion of sounding data in the time range not less than tₘₐₓ/t>30, in which tₘₐₓ is the maximal time of signal registration (this time is determined by the noise level). For example, if ρ=2 Ωm, tₘₐₓ=10 s and t ˜0.3 s, then r<1.7 km.

IP effect forces the use of the distances r>r_{IP}; here, r_{IP} is the distance at which the IP effect is sufficiently small. For example, at IP ˜0.3% (the background value) and p=2 μm, the distance r_{IP}>1 km provides conditions sufficient for suppressing the IP distortions to 30% at the time tₘₐₓ=10 s.

Therefore, in our example, the CDP area lies within the circular ring of 1 km<r<1.7 km.

The spatial accumulation in the CDP method is carried out by means of an 1D inversion scheme using simultaneously multiple transient processes; that is to say, a search of parameters of a layered section for which the experimental responses Ez (r₁), Ez(r₂), Ez(r_{N}) corresponding to receivers located in points r₁, r₂, r_{N} do minimize the functional

$$Ω = {\sum }_{i = 1}^{i = N} ‖ {Rz}_{i} - Ez ( {r}_{i} ) ‖ ,$$

in which Rz₁, Rz₂, . . . , Rz_{N} are the calculated responses corresponding to the model found. The final section gives a common result for the Tr-Rz₁-Rz₂, . . . group.

The simplest profile scheme of transmitter and receivers location shown in FIG. 1 can be used for CSEM CDP surveying using the TEMP-VEL/OEL method. At the first stage, all responses measured in each point are stacked in time, then they are grouped within the distances r₁>r>r₂ and used for 1D inversion as it is shown in FIG. 2.

to FIG. 3 illustrates an advanced spatial variant of the CDP method in which two receiver profiles Rp 1, Rp 2 are used simultaneously. If it is necessary to improve the accuracy of data, the number of the receivers can be increased.

The efficiency of surveying can be increased by the application of an apparatus producing processing and inversion synchronously with the measurement row data acquisition and, if necessary, a decision to add receivers and repeat the measurements.

### REFERENCE LIST

American patent publications

| | | |
|---|---|---|
| 2003/0052685 A1 | March 2003 | Ellingsrud et al. |
| 6628119 B1 | October 2003 | Eidesmo et al. |
| 4430653 | February 1984 | Coon et al. |
| 0071709 A1 | March 2008 | Strack |
| 7502690 B2 | March 2009 | Thomsen et al. |

Other patents

| | | |
|---|---|---|
| WO 02/14906 A1 | February 2002 | Ellingsrud et al. |
| WO 03/034096 A1 | April 2003 | Sinha et al. |
| WO 03/048812 A1 | June 2003 | MacGregor et al. |
| WO/2007/053025 | May 2007 | Barsukov et al. |

### OTHER PUBLICATIONS

Belay A., Zhabko G., Krinsly P., Pulse GPR research. http://radio.rphf.spbstu.ru/a263/pulsepic.
Chave A. D. and Cox C. S.; 1982: Controlled Electromagnetic Sources for Measuring Electrical conductivity Beneath the Oceans 1. Forward Problem and Model Study. Journal of Geophysical Research, 87, B7, pp. 5327-5338.
Chave A. D., Constable S. C., Edwards R. N.; 1991: Electrical Exploration Methods for the Seafloor. Chapter 12. Ed. by Nabighian, Applied Geophysics, v.2, Soc. Explor. Geophysics, Tusla, Okla. pp. 931-966.
Cheesman S. J., Edwards R. N., Chave A. D.; 1987. On the theory of sea floor conductivity mapping using transient electromagnetic systems. Geophysics, V. 52, N2, pp. 204-217.
Cox C. S., Constable S. C., Chave A. D., Webb S. C.; 1986: Controlled source electromagnetic sounding of the oceanic lithosphere. Nature, 320, pp. 52-54.
Edwards R. N., Law, L. K., Delaurier, J. M.; 1981: On measuring the electrical conductivity of the oceanic crust by a modified magnetometric resistivity method: J. Geophys. Res., V. 68, pp. 11609-11615.
Edwards R. N. and Chave A. D.; 1986: On the theory of a transient electric dipole-dipole method for mapping the conductivity of the sea floor. Geophysics, V. 51, pp. 984-987.
Eidesmo T., Ellingsrud S., MacGregor L. M., Constable S., Sinha M. C., Johansen S. E., Kong N. and Westerdahl, H.; 2002: Sea Bed Logging (SBL), a new method for remote and direct identification of hydrocarbon filled layers in deepwater areas. First Break, 20, March, pp. 144-152.
Greer A. A., MacGregor L. M. and Weaver R.; 2004: Remote mapping of hydrocarbon extent using marine Active Source EM sounding. 66^{th} EAGE Conference & Exhibition, Paris, France, 6-10 Jun. 2004.
Haber E., Ascher U. and Oldenburg D. W.; 2002: Inversion of 3D time domain electromagnetic data using an all-at-once approach: submitted for presentation at the 72^{nd} Ann. Internat. Mtg: Soc. of Expl. Geophys.
Howards R. N., Law L. K., Delaurier J. M.; 1981: On measuring the electrical conductivity of the oceanic crust by a modified magnetometric resistivity method: J. Geophys. Res., 86, pp. 11609-11615.
Kaufman A. A., and Keller G. V.; 1983: Frequency and transient soundings: Amsterdam, Elsevier Science Publ. Co., pp. 411-454.
MacGregor L., Sinha M.; 2000: Use of marine controlled-source electromagnetic sounding for sub-basalt exploration. Geophysical prospecting, v. 48, pp. 1091-1106.
MacGregor L., Tompkins M., Weaver R., Barker N.; 2004: Marine active source EM sounding for hydrocarbon detection. 66^{th} EAGE Conference & Exhibition, Paris, France, 6-10 Jun. 2004.
Tompkins M., Weaver R., MacGregor L.; 2004: Sensitivity to hydrocarbon targets using marine active source EM sounding: Diffusive EM mapping methods. 66^{th} EAGE Conference & Exhibition, Paris, France, 6-10 Jun. 2004.
Wright D. A., Ziolkowski A., and Hobbs B. A.; 2001: Hydrocarbon detection with a multichannel transient electromagnetic survey. 70^{th} Ann. Internat. Mtg., Soc. of Expl. Geophys.
Wicklund T. A., Fanavoll S.; 2004: Norwegian Sea: SBL case study. 66^{th} EAGE Conference & Exhibition, Paris, France, 6-10 Jun. 2004.
Ziolkovsky A., Hobbs B., Wright D.; 2002: First direct hydrocarbon detection and reservoir monitoring using transient electromagnetics. First Break, V. 20, No. 4, pp. 224-225

1. A method for the acquisition, processing and inversion of marine electromagnetic data; said method including the following steps:
recording the marine electromagnetic data by a system consisting of a plurality of synchronously working devices (Tr₁, . . . , Tr₄, Rz1, . . . , Rz9, Rz1-1, . . . , Rz2-9) arranged to record an electromagnetic field and installed on or near a sea floor (Sb) while an electromagnetic field is excited by pulses of electric current pumped in sea water (Sw) by a pulse generator (Sg) installed on board a vessel (V), and
selecting data, said marine electromagnetic data being common depth point marine electromagnetic data, characterized in that said common depth point marine electromagnetic data are the data selected from a plurality of raw records of the electromagnetic field measured in the time domain at a distance (offset) (r) between a transmitter (Tr₁, . . . , Tr₄) and a receiver (Rz1, . . . , Rz9; Rz1-1, . . . , Rz2-9), the distance satisfying the following conditions:
a) common depth point marine electromagnetic data consist of only a galvanic mode of the electromagnetic field; and
b) all the receivers (Rz1, . . . , Rz9; Rz1-1, Rz2-9) are located at a distance (offset) (r) that satisfies the condition r₁<r<r₂, in which r₁ is the distance from the transmitter (Tr₁, . . . , Tr₄) at which the effect of induced polarization is insignificant as compared with the measured response signal, whereas r₂ is the distance from the transmitter (Tr₁, . . . , Tr₄) at which the measured response signal is still considerable as compared with noise and, besides, the receiver (Rz1, . . . , Rz9; Rz1-1, . . . , Rz2-9) is still inside a near zone of the electromagnetic field determined by the condition r≦\sqrt{10⁷ρt/2}.

2. The method according to claim 1, wherein said processing involves inversion of said common depth point electromagnetic data with respect to resistivity of layers (Lb) existing within the earth, and a vertical extent of said layers (Lb).

3. The method according to claim 1 wherein said common depth point electromagnetic data are acquired by performing marine electromagnetic surveying operations comprising the steps of:
installation of the transmitter (Tr₁, Tr₂) emitting, in sea water (Sw), electric current pulses in a center of a selected receiver polygon located within an area previously identified as potentially containing a subsea hydrocarbon reservoir, while multiple receivers (Rz1-1, . . . , Rz1-9, Rz2-1, . . . , Rz2-9) arranged to register electromagnetic field responses are installed around the transmitter (Tr₁, Tr₂) at some distances (r) which probably satisfy the conditions a) and b) according to claim 1;
registration and processing of responses from the electromagnetic fields, displaying of the responses and evaluation of whether the responses satisfy the conditions a) and b) according to claim 1; in case of some or all data not satisfying these conditions, modification of location of the receivers (Rz1-1, . . . , Rz1-9, Rz2-1, . . . , Rz2-9) and repetition of measurements;
assignment of start parameters for resistivity (ρ) of said layers and the vertical extent of said layers, performance of joint inversion of all acquired data satisfying the conditions a) and b) according to claim 1, and determination of the resistivity (ρ) and vertical extent of the layers (Lb);
repetition of the inversion with different start models and evaluation of found layers' thicknesses and resistivity accuracy;
installation of additional receivers (Rzn-1, . . . , Rzn-9) inside the selected receiver polygon where the conditions a) and b) according to claim 1, determining validity of common depth point electromagnetic data, are satisfied, and recurrent acquisition of common depth point electromagnetic data if the attained accuracy is not satisfactory;
shift of the transmitter (Tr₁, Tr₂) and the receivers (Rz1-1, . . . , Rz1-9, Rz2-1, . . . , Rz2-9) along an assigned profile (Tp, Rp) extending into the area previously identified as potentially containing a subsea hydrocarbon reservoir, from the current receiver polygon to a adjacent receiver polygon, and repetition of all the steps described above;
repetition of all the operations described above over all the area previously identified as potentially containing a subsea hydrocarbon reservoir, stitching of all the sections consisting of the resistivity and vertical extent found for said layers, and 3D visualization of constructed resistivity model.

4. Apparatus for the acquisition, processing and inversion of marine electromagnetic data, said apparatus comprising:
said marine electromagnetic data are common depth point marine electromagnetic data selected from a plurality of electromagnetic field records measured in the time domain at a distance (offset) (r) between a transmitter (Tr₁, . . . , Tr₄) and a receiver (Rz1, . . . , Rz9, Rz1-1, . . . , Rz1-9, Rz2-1, . . . , Rz2-9) satisfying the conditions:
a) common depth point marine electromagnetic data consist of only a galvanic mode of an electromagnetic field; and
b) the receiver (Rz1, . . . , Rz9, Rz1-1, . . . , Rz1-9, Rz2-1, . . . , Rz2-9) is located at distance (offset) (r) satisfying the condition r₁<r<r₂, in which r₁ is the distance from the transmitter (Tr₁, . . . , Tr₄) at which effect of induced polarization is insignificant as compared with a measured response signal, whereas r₂ is the distance from the transmitter (Tr₁, . . . , Tr₄) at which the measured response signal is still considerable as compared with the noise, and the receiver (Rz1, . . . , Rz9, Rz1-1, . . . , Rz1-9, Rz2-1, . . . , Rz2-9) is still inside a near zone of the electromagnetic field which is being generated by the transmitter (Tr₁, . . . , Tr₄).

5. The apparatus according to claim 4, wherein said apparatus includes:
means for data storage arranged to store raw electromagnetic data received from marine electromagnetic surveying operations;
a mainframe computer, comprising means for accepting operator commands arranged to accept operator commands and means for receiving data arranged to receive data from said means for storing raw data and to transmit raw data together with said operator commands to an array processor unit; and
an array processor unit which is arranged to receive said operator commands and said raw data from said mainframe computer unit and process and invert said data in accordance with said operator commands and visualize the results essentially in real time;
while said operator commands relate to selecting of data which satisfy the common depth point conditions according to items a) and b) of claim 4, the processing and inversion of the common depth point data accumulated in time and space, 3D visualization of a constructed target model, decision-making regarding approval of a constructed target model and necessity of continuing measurements or changing positions of the transmitter (Tᵣ₁, . . . , Tr₄) and the receivers (Rz1, . . . , Rz9, Rz1-1, . . . , Rz1-9, Rz2-1, . . . , Rz2-9).
